(19) United States
(12) Patent Application Publication
(10) Pub. No.: US 2004/0093928 A1
(43) Pub. Date: May 20, 2004

(54) Rare earth metal sensor

(76) Inventors: Frank DiMeo JR., Danbury, CT (US); Philip S. Chen, Bethel, CT (US)

Correspondence Address: ATMI, INC., 7 COMMERCE DRIVE, DANBURY, CT, 06810, US

(21) Appl. No.: 10/300,275

(22) Filed: Nov. 20, 2002

(51) Int. Cl. G01N 9/00

(52) U.S. Cl. 73/23.2; 73/31.05

(57) ABSTRACT

A sensor with a protective barrier on a noble metal filter. The barrier protects the noble metal filter from catalytic poisons and any overdose of target particles. The barrier may be a polymer or non-polymer.

### GOVERNMENT RIGHTS

Embodiments described herein were made with Government support under Contract No. DE-FC36-99G010451, Department of Energy Phase II program.

### BACKGROUND

Embodiments described relate to detection of a target particle or molecule with a sensor. In particular, embodiments relate to detection of a target particle in a manner which preserves the character of a noble metal filter used in the detection.

### BACKGROUND OF THE RELATED ART

Environmental sensors may be used for a wide variety of purposes. For example, carbon monoxide sensors may be present in home garages to detect unsafe levels of carbon monoxide, propane sensors may be used in conjunction with gas grills, and industrial sensors may be used to detect potential exposure to unsafe levels of chemicals or toxins at chemical plants, coal mines, and semiconductor fabrication facilities. Additionally, hydrogen sensors may be used in conjunction with fuel cell technology, where the sensors may be employed to detect possible hydrogen escape from fuel cells.

In some cases, sensors may be fabricated in chip scale as part of a wafer. For example, various deposition, patterning, and etching techniques may be performed utilizing a silicon-based wafer substrate to form sensor platforms for each die of the wafer. The sensor platforms may be micro-hotplate structures to precisely heat materials deposited thereon. For example, a rare earth metal such as yttrium, reactive with hydrogen, may be deposited on each micro-hotplate structure. In a completed sensor, the ability for the yttrium to react with hydrogen for detection thereof may be driven relative to the temperature of the yttrium. For example, heat provided by activation of the underlying micro-hotplate structure. Additionally, in order to ensure reaction of the yttrium with hydrogen for hydrogen detection, a palladium-based filter may be formed above the yttrium to prevent other molecules, such as oxygen, from reacting with the yttrium. In this manner, the completed sensor may be tailored specifically to hydrogen detection. That is, the palladium-based filter material will filter materials reactive with the underlying yttrium, with a potential exception of hydrogen, which may pass beyond the filter and to the yttrium.

Unfortunately, however, in filtering undesirable particles away from the yttrium, the palladium-based filter is subject to degradation by highly concentrations of hydrogen and catalytic poisons. That is, even though hydrogen may pass through the palladium-based filter in a detectable amount, much of the hydrogen remains associated with the filter leading to cracking and degradation. Additionally, oxygen and other particles, trapped by the palladium-based filter, maybe catalytic poisons which also tend to general degradation of the filter.

### SUMMARY

An embodiment of a sensor is described including a rare earth metal layer with a noble metal filter thereon. A barrier is included on the noble metal filter for protection from degradation.

### BRIEF DESCRIPTION OF THE DRAWINGS

FIG. 1 is a side cross-sectional view of an embodiment of a rare earth metal sensor.

FIG. 2 is an exploded cross-sectional view of the rare earth metal sensor of FIG. 1 taken from section 2-2 of FIG. 1.

FIG. 3A is a cross sectional view of an embodiment of a sensor portion having an insulating layer deposited thereon.

FIG. 3B is a cross sectional view of the sensor portion of FIG. 3A with trenches etched there into.

FIG. 3C is a cross-sectional view of the sensor portion of FIG. 3B with a rare earth metal layer deposited thereon.

FIG. 3D is a cross-sectional view of the sensor portion of FIG. 3C with a noble metal filter deposited on the rare earth metal layer.

FIG. 3E is a cross-sectional view of the sensor portion of FIG. 3D with a barrier on the noble metal filter.

FIG. 4 is a flow chart summarizing embodiments of forming a noble metal sensor such as that shown in FIG. 1.

### DETAILED DESCRIPTION

While embodiments are described with reference to certain hydrogen sensors utilizing a micro-hotplate platform, embodiments may be applicable to sensors of other types. This may include sensors to detect other gasses which may employ a micro-hotplate or alternative platform. Embodiments described may be particularly useful when a sensor includes a filter that may be subjected to poisons or overdose concentrations of particles capable of damaging or degrading the filter.

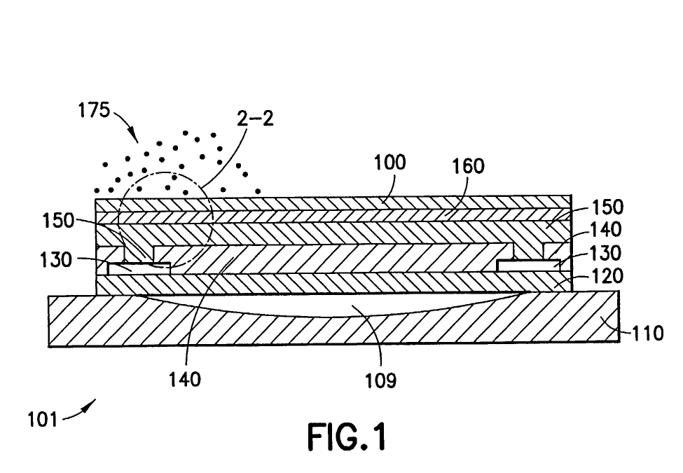

Referring to FIG. 1, an embodiment of a sensor 101 is shown. The sensor 101 utilizes a conventional micro-hotplate platform which includes a silicon based substrate 110. A heating layer 120 may be supported by the silicon-based substrate 110. The heating layer 120 may actually be a multi-layered structure including a heating element with insulating and distribution layers associated therewith. As described further herein, the particular configuration of the heating layer 120 is a matter of design choice depending upon factors such as the distribution and amount of heat to be employed by the sensor 101

The heating layer 120 of the sensing mechanism rests on the substrate 110 as indicated above. Additionally, a thin supporting layer 115 may be provided between the substrate 110 and the heating layer 120 for additional support of the sensing mechanism. The supporting layer 115 may be of silicon dioxide or other compatible material. As shown in FIG. 1, the sensing mechanism of the sensor 101 is actually both suspended above and supported by the substrate 110 due to the location of the pit 109. Thus, added support may be provided by the presence of the supporting layer 115.

Continuing with reference to FIG. 1, the sensing mechanism includes a rare earth metal layer 150 which is coupled to contacts 130 of the micro-hotplate platform. An insulating dielectric material 140 may be disposed between the contacts 130. In one embodiment, the sensing mechanism may be configured for detecting a target particle such as hydrogen. In this embodiment, the rare earth metal layer 150 may be configured to undergo a chemical reaction as described further herein to indicate when hydrogen is sensed. In one such embodiment, the contacts 130 are of aluminum or other suitable material for electrical detection of such a chemical change. This detection may be transmitted by conventional means for processing to indicate the detection of hydrogen.

The embodiment shown in FIG. 1 includes a noble metal filter 160 of less than about 1,000 microns in thickness above the rare earth metal layer 150. The noble metal filter 160 is configured to prevent the reaction of non-target molecules with the material of the rare earth metal layer 150. For example, in one embodiment, described further below, the sensor 101 may be configured for hydrogen detection with a rare earth metal layer 150 of an yttrium magnesium alloy.

In order to prevent other particles, such as nitrogen or oxygen, from reacting with the yttrium of the rare earth metal layer 150, the overlying noble metal filter 160 may be of a noble metal alloy such as a palladium aluminum alloy. In this manner, hydrogen, which may be present in a region 175 adjacent the sensor 175 may pass through the noble metal filter 160 to the rare earth metal layer 150 to react with the yttrium thereof. However, other non-target particles are substantially blocked by the noble metal filter 160. Thus, the sensor 101 is selective for hydrogen.

The embodiment described above includes an yttrium based rare earth metal layer 150 for hydrogen detection, with a palladium based noble metal filter 160 there above. However, as described futher herein other materials may be used for such filtering and detection.

Continuing with reference to FIG. 1, the sensor 101 is shown with a barrier 100 above the noble metal filter 160. The barrier 160 helps prevent catalytic poisons or harmful amounts of other particles which may be present in a nearby region 175 from coming into contact with and degrading the noble metal filter 160. For example, as described above, the noble metal filter 160 is configured to allow substantially only non-reactive or target particles to pass through to the underlying rare earth metal layer 150. As a result, a large amount of catalytic poisons, such as carbon monoxide, oxides sulfides, and even some target particles may remain associated with the noble metal filter 160 resulting in its gradual degradation. However, a barrier 100, configured to block catalytic poisons, overdose amounts of target particles, or other harmful particles may be placed above the noble metal filter 160.

In an embodiment where the sensor 101 is for hydrogen detection as described above, the barrier 100 may be a conventional polymer or other suitable material as described further below. The particular material chosen for the barrier may be selected as a matter of design choice depending upon factors such as temperatures to be encountered by the sensor 101 or particular poisons or other particles to be blocked away from the underlying noble metal filter 160.

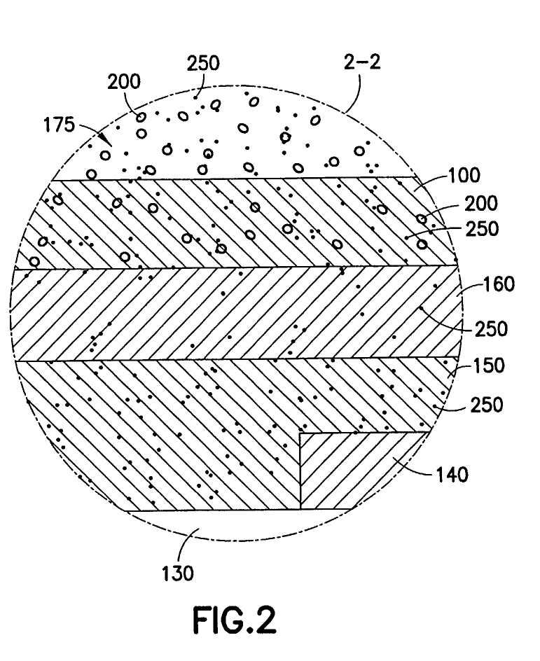

Referring to FIG. 2 detection of target particles 250, such as the above noted hydrogen, is described in further detail. FIG. 2 is an exploded view, taken from 2-2 of FIG. 1, revealing a portion of the sensor 101 adjacent a region 175 which includes target particles 250 to be detected. In an embodiment where the target particles 250 include hydrogen, the barrier 100 may be a conventional polymer such as a polyimide, an acrylic, nylon, a urethane, an epoxy, a fluorine containing resin, polystyrene, or other material to allow hydrogen to pass there through. Additionally, where the sensor 101 is to encounter temperatures in excess of about 200° C., the barrier 100 may be a sufficiently thin layer of silicon dioxide or aluminum to allow hydrogen to pass there through. In this manner, a functional barrier 100 is present that may tolerate exposure to temperatures in excess of about 200° C.

Continuing with reference to FIG. 2, the region 175 adjacent the barrier 100 includes non-target particles 200 which have the potential to be harmful to the noble metal filter 160. For example, the non-target particles 200 may include catalytic poisons such as various sulfides. However, the barrier 100 is configured to prevent a significant amount of such non-target particles 200 from passing through to the noble metal filter 160.

Referring to FIG. 2, only the target particles 250, in this case hydrogen, are shown passing beyond the barrier 100 to the underlying noble metal filter 160. However, the barrier 100 does not necessarily prevent all non-target particles 200 from reaching the noble metal filter 160. Rather, the barrier 100 prevents passage through to the noble metal filter 160 a significant amount of those particular non-target particles 200, such as catalytic poisons, which may be harmful to the noble metal filter 160. Additionally, in cases where the target particles 250 may be present in extremely high concentrations, a certain amount of the target particles 250 may remain associated with the barrier 100. In this manner, the likelihood of damage to the noble metal filter 160 as a result of exposure to an overdose amount of the target particle 250 may be minimized.

As shown in FIG. 2, the target particles 250 eventually reach the rare earth metal layer 150. As described above, this leads to a chemical reaction within the rare earth metal layer 150 which may be detected to indicate that the target particles have been sensed. In an embodiment where the target particles 250 include hydrogen and the rare earth metal layer 150 is of yttrium, this chemical change may be seen as:

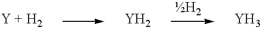

Once the irreversible change in Y to YH₂ occurs, the reversible change from a metallic species (YH₂) to one that is semiconducting (YH₃) may take place based on continued exposure of hydrogen to the yttrium rare earth metal layer 150. A detectable change in electrical character of the rare earth metal layer 150 occurs as the metallic species becomes semiconducting. Detection of this electrical change at a contact 130 indicates presence of the target particle 250 of hydrogen. The electrical change detected may be in the form of changed resistance, conductance, capacitance or other electrical property. Additionally, a change in optical appearance of the rare earth metal layer allows detection of hydrogen exposure.

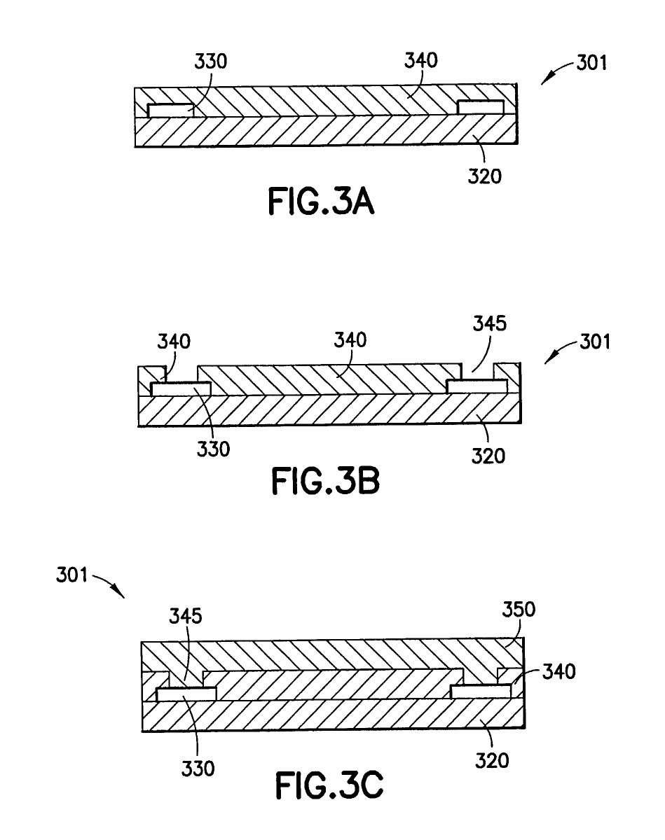

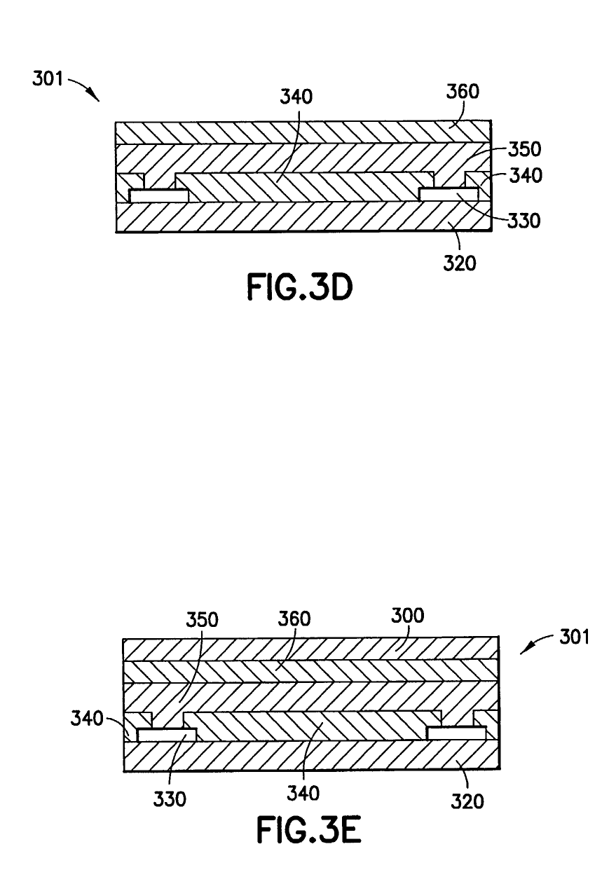

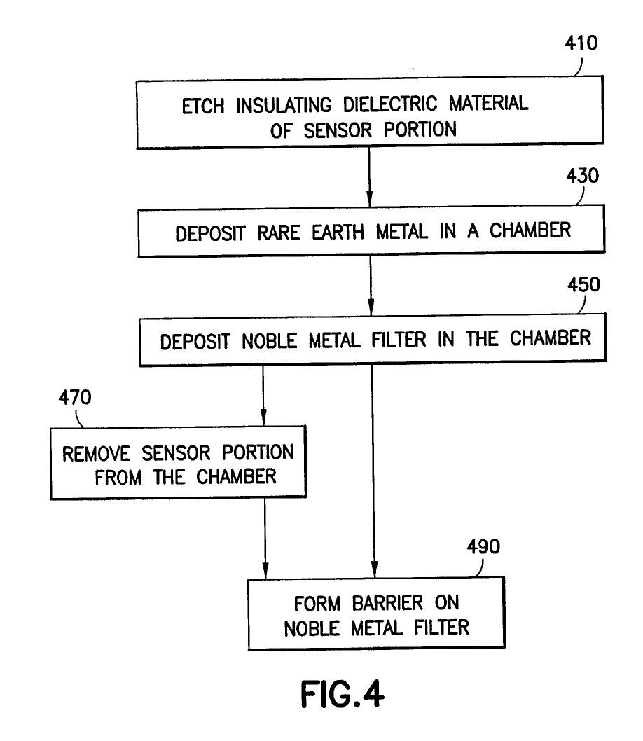

With reference to FIGS. 3A-3E, the formation of a sensor portion 301 having a barrier 300 similar to that described above is discussed in detail. The embodiments described with reference to FIGS. 3A-3E describe the formation of a particular hydrogen sensor at the chip level. However, embodiments of the process shown may be applied at the wafer level to an entire wafer including a plurality of sensors to be formed. As described above, alternate sensors may be formed and employed according to the methods described herein. Additionally, FIG. 4 is a flow chart summarizing embodiments of forming a sensor as described in FIGS. 3A-3E. FIG. 4 is referenced throughout remaining portions of the description as an aid in describing the embodiments referenced in FIGS. 3A-3E.

FIG. 3A shows a sensor portion 301 which includes micro-hotplate features of a heating layer 320 having contacts 330 there above. An insulating dielectric material 340 may be disposed above the contacts 330 and the heating layer 320. As indicated at 410 of FIG. 4, the sensor portion 301 of FIG. 3A is then etched following application of conventional photolithographic techniques. That is, a conventional etchant may be directed to etch through selected portions of the insulating dielectric material 340 through to the contacts 330 as shown in FIG. 3B. Thus, vias 345 are formed.

In one embodiment, a rare earth metal may then be deposited as shown at 430 to form a rare earth metal layer 350 which fills the vias 345 and couples to the contacts 330 as shown in FIG. 3C. In one embodiment, the rare earth metal layer 350 is deposited by Electron Beam Physical Vapor Deposition (EB PVD) where a rare earth element such as yttrium is placed in the vicinity of the sensor portion 301 within a deposition chamber. An electron beam is applied to the yttrium leading to its uniform deposition throughout the chamber and on the sensor portion 301 where the yttrium rare earth metal layer 350 is formed. A temperature of between about 22° C. and about 400° C. may be maintained in the chamber along with a pressure of between about 10⁻⁶ torr and 10⁻⁸ torr.

The rare earth metal to form the rare earth metal layer 350 described above is yttrium. However, scandium and lanthanium, along with any lanthanide, actinide alloy or combination thereof including with any Group III element may be employed. The group II elements may include calcium, barium, strontium, magnesium and radium.

As shown in FIG. 3D and at 450 of FIG. 4, a noble metal filter 360 is then deposited above the rare earth metal layer 350. The noble metal filter 360 may be between about 100 angstroms and about 200 angstroms thick. Additionally, the noble metal layer may be thicker than about 200 angstroms where a portion of the target particle 250 is to be blocked away from the rare earth element layer 150, for example, to prevent overdosing thereby.

To prevent oxidation of the rare earth metal layer 350, deposition of the noble metal filter 360 may take place in the same chamber where deposition of the rare earth metal layer 350 occurred. That is, the sensor portion 301 is not removed from the chamber and exposed to air of an outside environment while the rare earth metal layer 350 is uncovered. Rather, for example, palladium may be introduced to the vicinity of the sensor portion 301 within the chamber where an EB PVD method may be applied, such as that described above, to form a palladium noble metal filter 360.

Other materials which may be employed to form the noble metal filter 360 include platinum, irridium, silver, gold, cobalt, aluminum and alloys thereof including with palladium. Other deposition techniques may be employed to form the rare earth element layer 350 and the noble metal filter 360. For example, metal-organic CVD (MOCVD) and plasma enhanced CVD (PECVD) techniques may be employed. Electroplating and electroless plating techniques may also be employed.

Once the noble metal filter 360 is applied, the sensor portion 301 may be removed from the chamber as indicated at 470 without risk of oxidation to the rare earth metal layer 350 which could hinder performance of the sensor portion 301. The barrier 300 may now be formed on the surface of the noble metal filter 360 as indicated at 490 and shown in FIG. 3E. Where the barrier 300 is of conventional polymer materials such as those described above, it may be applied by conventional spin-on or other low temperature techniques not requiring temperatures to exceed about 200° C. Alternatively, the barrier may be of silicon dioxide, aluminum, or other materials where temperatures in excess of about 200° C. may be employed. In such embodiments EB PVD, or other vapor deposition techniques may be employed to form the barrier 300. As shown in FIG. 4, this may include use of the same chamber referenced above without removal of the sensor portion therefrom in order to form the barrier.

The particular techniques employed to deposit the rare earth element layer 340, the noble metal filter 350, and the barrier 300 are a matter of design choice depending on factors such as the types of materials to be used and the thicknesses to be achieved. As shown in FIG. 3E, the sensor portion 301 may now be secured to a thin supporting layer 315 or larger substrate as described with reference to FIG. 1. Thus, a sensor 302 with a protected noble metal filter 360 is formed.

Embodiments described above include use of a noble metal filter with a sensor in a manner where the filter is protected from catalytic poisons or overdose amounts of target particles. This prevents degradation of the filter and allows more useful employment of the sensor where increased concentrations of target particles are present.

Embodiments of the invention include sensors having noble metal filters protected by a barrier. Although exemplary embodiments describe particular hydrogen sensor configurations and methods additional embodiments and features are possible. For example, the heating layer of the sensor may be activated to drive the rare earth element layer from a semiconducting state to a metal state. In this manner, the sensor may be repeatedly used for detection of the target particle. Additionally, many changes, modifications, and substitutions may be made without departing from the spirit and scope of these embodiments.

We claim:

1. A sensor comprising:
a rare earth metal layer;
a noble metal filter on said rare earth metal layer; and
a barrier on said noble metal filter to protect the noble metal filter from degradation.

2. The sensor of claim 1 wherein said rare earth metal layer includes one of yttrium, scandium, lanthanum, lathanide actinide, calcium, barium, strontium, magnesium and radium.

3. The sensor of claim 1 configured to detect hydrogen.

4. The sensor of claim 1 wherein said noble metal filter includes one of palladium, platinum, irridium, silver, gold and cobalt.

5. The sensor of claim 4 wherein said noble metal filter is between about 100 angstroms and about 200 angstroms and is permeable to hydrogen.

6. The sensor of claim 4 wherein said noble metal filter is thicker than about 200 angstroms to decrease permeability thereof to hydrogen.

7. A polymer barrier to protect a noble metal filter of a sensor from degradation.

8. The polymer barrier of claim 7 including one of a polyimide, an acrylic, nylon, urethane, an epoxy, a fluorine resin, and polystyrene.

9. A non-polymer barrier to protect a noble metal filter of a sensor from degration.

10. The non-polymer barrier of claim 9 including one of silicon dioxide and aluminum.

11. A method comprising forming a barrier on a noble metal filter of a sensor to protect the noble metal filter from degradation.

12. The method of claim 11 further comprising depositing the noble metal filter on a rare earth metal of the sensor prior to said forming and by a vapor deposition technique in a chamber.

13. The method of claim 12 further comprising depositing a rare earth metal layer on a substrate of the sensor prior to said depositing of the noble metal filter and by the vapor deposition technique in the chamber.

14. The method of claim 13 wherein said forming is by the vapor deposition technique in the chamber.

15. A method comprising sensing a target particle with a sensor having a noble metal layer with a barrier thereon for protection.

16. The method of claim 15 wherein the target particle is hydrogen.

17. The method of claim 15 wherein the protection is from an overdose of hydrogen.

18. The method of claim 15 further comprising heating a portion of the sensor after said sensing to allow additional sensing by the sensor.

19. The method of claim 15 wherein the protection is from a catalytic poison.

20. The method of claim 19 wherein the catalytic poison is one of carbon monoxide, an oxide, and a sulfide.
